(19) United States
(12) Patent Application Publication
(10) Pub. No.: US 2007/0184329 A1
(43) Pub. Date: Aug. 9, 2007

(54) Liquid feed fuel cell with orientation-independent fuel delivery capability

(76) Inventors: Hongsun Kim, Port Coquitlam (CA); Ruiming Zhang, Urbana, IL (US); Hee Soo Kim, Savoy, IL (US); Zakia Khan, Champaign, IL (US); Sharon Blair, Coquitlam (CA)

Correspondence Address: MCANDREWS HELD & MALLOY, LTD, 500 WEST MADISON STREET, SUITE 3400, CHICAGO, IL, 60661, US

(21) Appl. No.: 11/348,691

(22) Filed: Feb. 7, 2006

(51) Int. Cl. H01M 8/02; H01M 8/10; H01M 4/96

(52) U.S. Cl. 429/38; 429/44; 429/30; 429/42; 429/13

(57) ABSTRACT

A direct organic liquid feed unit fuel cell comprises an anode current collector, a cathode current collector, a membrane electrode assembly, and a fuel delivery layer for diluting a concentrated fuel stream and delivering the fuel stream to the anode at a uniform concentration across the planar extent of the anode, independently of the orientation of the fuel cell.

### FIELD OF THE INVENTION

The present invention relates to liquid feed fuel cells and delivery of the fuel to the anode of the fuel cell. The present invention further relates to the delivery of fuel to the anode of the fuel cell so that the concentration of fuel at the anode is uniform across the anode regardless of the orientation of the fuel cell. The present invention further relates to the delivery of fuel to the anode of the fuel cell, where the fuel delivery system is integrated into the unit fuel cell.

### BACKGROUND OF INVENTION

Fuel cells are electrochemical cells in which a free energy change resulting from a fuel oxidation reaction is converted into electrical energy. Applications for fuel cells include battery replacement; mini- and microelectronics such as portable electronic devices; sensors such as gas detectors, seismic sensors, and infrared sensors; electromechanical devices; automotive engines and other transportation power generators; power plants; and many others. One advantage of fuel cells is that they are substantially pollution-free.

Electrochemical fuel cells convert fuel and oxidant fluid streams to electricity and reaction product. Solid polymer electrochemical fuel cells generally employ a membrane electrode assembly (MEA) comprising a solid polymer electrolyte or ion-exchange membrane disposed between two porous electrically conductive electrode layers. An electrocatalyst is typically disposed at each membrane/electrode layer interface to induce the desired electrochemical reaction.

The electrode substrate typically comprises a sheet of porous, electrically conductive material, such as carbon fiber paper or carbon cloth. The layer of electrocatalyst is typically in the form of finely comminuted metal, such as platinum, palladium, or ruthenium, and is disposed on the surface of the electrode substrate at the interface with the membrane electrolyte in order to induce the desired electrochemical reaction. In a single cell, the electrodes are electrically coupled to provide a path for conducting electrons between the electrodes through an external load.

The fuel stream directed to the anode by the fuel flow field migrates through the porous anode and is oxidized at the anode electrocatalyst layer. The oxidant stream directed to the cathode by the oxidant flow field migrates through the porous cathode and is reduced at the cathode electrocatalyst layer.

Electrochemical fuel cells can employ gaseous fuels and oxidants, for example, those operating on molecular hydrogen as the fuel and oxygen in air or a carrier gas (or substantially pure oxygen) as the oxidant. In hydrogen fuel cells, hydrogen gas is oxidized to form water, with a useful electrical current produced as a byproduct of the oxidation reaction. A solid polymer membrane electrolyte layer can separate the hydrogen fuel from the oxygen. The anode and cathode are arranged on opposite faces of the membrane. Electron flow along the electrical connection between the anode and the cathode provides electrical power to load(s) interposed in circuit with the electrical connection between the anode and the cathode. The anode and cathode reactions in hydrogen/oxygen fuel cells are shown in the following equations:
Anode reaction: H₂→2H⁺+2e⁻
Cathode reaction: ½O₂+2H⁺+2e³¹ →H₂O

The catalyzed reaction at the anode produces hydrogen cations (protons) from the fuel supply. The ion-exchange membrane facilitates the migration of protons from the anode to the cathode. In addition to conducting protons, the membrane isolates the hydrogen-containing gaseous fuel stream from the oxygen-containing gaseous oxidant stream. At the cathode electrocatalyst layer, oxygen reacts with the protons that have crossed the membrane to form water as the reaction product. Hydrogen fuel cells are impractical for many applications, however, because of difficulties related to storing and handling hydrogen gas.

Organic fuel cells can prove useful in many applications as an alternative to hydrogen fuel cells. In an organic fuel cell, an organic fuel such as methanol or formic acid is oxidized to carbon dioxide at an anode, while air or oxygen is simultaneously reduced to water at a cathode. One advantage over hydrogen fuel cells is that organic/air fuel cells can be operated with a liquid organic fuel. This alleviates or eliminates problems associated with hydrogen gas handling and storage. Some organic fuel cells require initial conversion of the organic fuel to hydrogen gas by a reformer. These are referred to as “indirect” fuel cells. A reformer increases cell size, cost, complexity, and start up time. Other types of organic fuel cells, sometimes referred to as “direct” or “direct feed” fuel cells, alleviate or eliminate these disadvantages by directly oxidizing the organic fuel without conversion to hydrogen gas. To date, fuels employed in direct organic fuel cell development include methanol and other alcohols, as well as formic acid and other simple acids.

In fuel cells of this type the reaction at the anode produces protons, as in the hydrogen/oxygen fuel cell described above, however the protons (along with carbon dioxide) arise from the oxidation of the organic fuel, such as formic acid. An electrocatalyst promotes the organic fuel oxidation at the anode. The organic fuel can alternatively be supplied to the anode as vapor, but it is generally advantageous to supply the organic fuel to the anode as a liquid, preferably as an aqueous solution. The anode and cathode reactions in a direct formic acid fuel cell are shown in the following equations:
Anode reaction: HCOOH→2H⁺+CO₂+2e⁻
Cathode reaction: O₂+2H⁺+2e⁻2H₂O
Overall reaction: HCOOH+O₂→CO₂+2H₂O

The protons formed at the anode electrocatalyst migrate through the ion-exchange membrane from the anode to the cathode, and at the cathode electrocatalyst layer, the oxidant reacts with the protons to form water.

One obstacle to the widespread commercialization of direct fuel cell technology is the inability to use highly concentrated fuel to feed the fuel cell. It is advantageous to store fuel for mobile devices at high fuel concentrations so that the energy density produced by the fuel cell is as high as possible. If a fuel cell can produce a higher energy density, the fuel cell will be able to power devices with a wider range of energy requirements. Utilizing highly concentrated fuel can be a problem for both methanol fuel cells and formic acid fuel cells. In methanol fuel cells, highly concentrated fuel causes fuel to cross-over the membrane, which causes a reduction in energy efficiency of the fuel cell. In formic acid fuel cells, fuel concentrations above a certain level can cause undesirable chemical changes to the membrane. When a highly concentrated formic acid fuel solution is employed in a liquid feed fuel cell, the fuel cell performance can decrease more quickly than desirable for many practical applications.

One existing solution for diluting high concentrations of liquid fuel is to add a dilution apparatus to the fuel cell system. For example, water formed as a product of the fuel cell reaction can be mixed with the incoming concentrated fuel to dilute the fuel. This solution, however, increases the size and complexity of the fuel cell. Additional parts provide for the mixture of product water with concentrated fuel. These additional parts are usually arranged in an apparatus that is separate from the unit fuel cell. In addition, the solution requires carefully controlling the amount of recaptured water mixed with the concentrated fuel to provide for a particular dilution factor of the fuel.

Another possible solution is to provide fuel to the anode by wicking the fuel to the anode. This technique, however, provides for only limited control of the amount of fuel provided to the anode and can also provide undesirable fuel delivery gradients to the anode. In addition, this technique can yield low conductivity across the membrane. A membrane with low conductivity is not suitable for use between the anode and the cathode of a fuel cell because it does not allow for sufficient transfer of the protons from the anode to the cathode across the membrane.

Another possible solution is to provide small doses of fuel to the anode with a fuel control valve. This technique, however, often results in fuel being delivered to the anode at varying concentrations as the anode is traversed in-plane (that is, in the x- and y-directions, parallel to the planar major surfaces of the anode substrate; the z-direction is perpendicular to the planar major surfaces of the anode, and traverses the anode cross-sectional thickness). As used herein, the “planar extent” of the anode refers to its extent in the x- and y-directions.

A drawback to many of the existing solutions is that the concentration of fuel contacting the anode is often not constant across the planar extent of the anode. In particular, gravity can also cause an undesirable concentration gradient of fuel across the anode planar extent. Liquid fuel will be affected by gravity, causing a buildup of fluid at the bottom of the fuel cell. An unfavorable fuel concentration gradient (such as that caused by gravity) decreases the energy density the fuel cell can produce. It is advantageous for the concentration of fuel at each point on the anode to be independent of the spatial orientation of the fuel cell.

One of the products of the reaction at the anode is a gas, such as carbon dioxide. It is advantageous for a fuel cell to appropriately dispose of this gaseous reaction product.

Therefore, it is advantageous to provide a fuel cell that can use highly concentrated fuel as a feed and deliver fuel at a uniform and diluted concentration across the anode. This uniform concentration should be provided independently of the spatial orientation of the fuel cell.

### SUMMARY OF THE INVENTION

One or more shortcomings of conventional methods and apparatuses for delivering liquid fuel to the anode of a liquid feed fuel cell are overcome by the present system and method for delivering liquid fuel to an anode at a uniform concentration. In one embodiment, the system includes a liquid feed fuel cell comprising:
(a) an anode comprising carbon and having an anode electrocatalyst associated therewith
(b) a cathode having a cathode electrocatalyst associated therewith;
(c) a proton exchange membrane interposed between the anode and the cathode, wherein a fluid fuel stream is directed to and oxidized at the anode; and
(d) an electrically conductive fuel delivery layer having a fuel stream side and an anode side interposed between the fluid fuel stream and the anode, the fuel delivery layer comprising hydrophilic porous graphite impregnated with a fuel-permeable polymer.

In a preferred embodiment, the fuel delivery layer has an open porosity of greater than about 25%. The fuel delivery layer pores are preferably between about 1 micron and about 2 microns in diameter. The fuel delivery layer is preferably rendered hydrophilic by incorporating therein a material that effects an increase in hydrophilicity of the layer. The preferred hydrophilicity-increasing material is tin oxide. In another preferred embodiment, the fuel delivery layer has a wettability ratio of greater than about 0.2.

In a preferred embodiment, the fuel-permeable polymer is perfluorosulfonic acid polymer. The fuel delivery layer preferably further comprises a coating of fuel-permeable polymer on the fuel delivery layer surface facing the fuel stream. The fuel-permeable polymer coating preferably forms a pattern on the fuel delivery layer.

In a preferred embodiment, the fuel delivery layer further comprises channels to exhaust a product gas stream from the anode.

In another embodiment, a liquid feed fuel cell comprises:
(a) an anode comprising carbon and having an anode electrocatalyst associated therewith;
(b) a cathode having a cathode electrocatalyst associated therewith;
(c) a proton exchange membrane interposed between the anode and the cathode, wherein a fluid fuel stream is directed to and oxidized at the anode;
(d) an electrically conductive fuel distribution layer interposed between the fluid fuel stream and the anode; and
(e) an electrically conductive fuel delivery layer interposed between the fuel distribution layer and the anode, the fuel delivery layer comprising hydrophilic porous graphite impregnated with a fuel-permeable polymer.

In a preferred embodiment, the fuel distribution layer comprises hydrophilic porous graphite. The fuel distribution layer preferably has an open porosity of greater than about 50%. The fuel distribution layer preferably has pores that are between about 30 microns and about 100 microns in diameter. The fuel distribution layer preferably comprises graphite sheet material (sometimes referred to as graphite paper) impregnated with polytetrafluoroethylene (PTFE). The fuel distribution layer preferably has openings or holes formed in the graphite sheet material to uniformly distribute the fuel stream across the planar extent of the anode.

In a preferred embodiment, the fuel delivery layer has an open porosity of greater than about 25%. The pores in the fuel delivery layer are preferably between about 1 micron and 2 microns in diameter. The fuel delivery layer is preferably rendered hydrophilic by incorporating therein a material that effects an increase in hydrophilicity of the layer. The preferred hydrophilicity-increasing material is tin oxide.

In a preferred embodiment, the fuel-permeable polymer is perfluorosulfonic acid polymer.

In a preferred embodiment, the fuel delivery layer further comprises channels to exhaust a product gas stream from the anode.

In another embodiment, a liquid feed fuel cell comprises:
(a) an anode comprising carbon and having an anode electrocatalyst associated therewith;
(b) a cathode having a cathode electrocatalyst associated therewith;
(c) a proton exchange membrane interposed between the anode and the cathode, wherein a fluid fuel stream is directed to and oxidized at the anode;
(d) an electrically conductive fuel delivery layer interposed between the fluid fuel stream and the anode, wherein the fuel delivery layer comprises hydrophilic porous graphite impregnated with a fuel-permeable polymer; and
(e) a gas diffusion layer interposed between the fuel delivery layer and the anode, the gas diffusion layer comprising hydrophilic porous graphite with a porosity greater than about 50% and pores between about 30 microns and 100 microns in diameter.

In a preferred embodiment, the fuel delivery layer has an open porosity of greater than about 25%. The pores in the fuel delivery layer are preferably between about 1 micron and about 2 microns in diameter. The fuel delivery layer is preferably rendered hydrophilic by incorporating therein a material that effects an increase in hydrophilicity of the layer. The preferred hydrophilicity-increasing material is tin oxide.

In another preferred embodiment, the fuel-permeable polymer is perfluorosulfonic acid polymer. The fuel delivery layer preferably further comprises a coating of fuel-permeable polymer on the surface of the fuel delivery layer facing the fuel stream. The coating of fuel permeable polymer preferably forms a pattern on the fuel delivery layer.

In another embodiment, a system distributes and dilutes a concentrated liquid fuel solution across an electrode having a planar conformation. The system comprises:
(a) a fuel distribution layer overlaying and fluidly connected to the electrode, the fluid distribution layer distributing the fuel solution uniformly across the planar extent of the fuel distribution layer; and
(b) a fuel delivery layer overlaying and fluidly connected to the electrode, the fuel delivery layer decreasing fuel concentration by a predetermined dilution factor such that diffusion of fuel toward the electrode occurs independently of system spatial orientation.

In another embodiment, a method for delivering fuel to an anode of a liquid feed fuel cell at a constant concentration across the anode independently of the spatial orientation of the fuel cell comprises:
(a) delivering dosed amounts of concentrated fuel to an inlet of the fuel cell at predetermined times;
(b) distributing the fuel such that the concentration of fuel is constant across the planar extent of the anode by passing the fuel through a fuel distribution layer; and
(c) diluting the fuel by a predetermined dilution factor by passing the fuel through a fuel delivery layer that contains water and effects diffusion of the fuel independently of fuel cell spatial orientation.

In another embodiment, a fuel delivery layer for a liquid feed fuel cell comprises an anode, a cathode, and a proton exchange membrane disposed between the anode and the cathode, the fuel delivery layer comprising hydrophilic porous graphite with an open porosity greater than about 25% and pore size between about 1 micron and about 2 microns.

In another embodiment, a liquid feed fuel cell comprises:
(a) an anode comprising carbon and having an anode electrocatalyst associated therewith;
(b) a cathode having a cathode electrocatalyst associated therewith;
(c) a proton exchange membrane interposed between the anode and the cathode, wherein a fluid fuel stream is directable to and oxidizable at the anode;
(d) an electrically conductive fuel delivery layer interposed between the fluid fuel stream and the anode, the fuel delivery layer comprising hydrophilic porous graphite impregnated with a fuel-permeable polymer;
(e) a cathode current collector plate formed of electrically conductive material that is electrically connected to the cathode;
(f) an anode current collector plate formed of electrically conductive material and having a fuel inlet port and a waste outlet port formed therein, the anode current collector plate electrically connected to the anode;
(g) a compressible gasket; and
(h) a rigid insulating gasket.
   At least one of the cathode current collector plate and the anode current collector plate is formed with securing portions extending outwardly therefrom, and the anode current collector plate, the insulating gasket, the fuel delivery layer, the anode, the proton exchange membrane, the cathode, the compressible gasket and the rigid insulating gasket are assembled in a stack with the cathode current collector plate. The fuel cell is consolidated by compressing the securing portions against the insulating gasket and the other of the at least one of the cathode current collector plate and the anode collector plate such that the stack is uniformly compressed.

In a preferred embodiment, the liquid feed fuel cell further comprises an electrically conductive fuel distribution layer interposed between the fluid fuel stream and the fuel delivery layer, the fuel distribution layer comprising graphite sheet material impregnated with a quantity of PTFE. The liquid feed fuel cell preferably further comprises a second insulating gasket, the other of the cathode current collector plate and the anode current collector plate preferably has securing portions formed therein, and the second insulating gasket is preferably positioned adjacent the other of the at least one of the cathode current collector plate and the anode current collector plate such that the fuel cell is consolidated by compressing the securing portions against the first and second insulating gaskets and such that the stack is uniformly compressed and resistance between the anode current collector plate and the cathode current collector plate is thereby reduced.

### BRIEF DESCRIPTION OF THE DRAWINGS

FIG. 1 is a schematic diagram of a prior art fuel dilution system.

FIG. 2 is an exploded view schematic diagram of an exemplary direct liquid feed fuel cell having a fuel delivery layer.

FIG. 3 is an exploded view schematic diagram of an exemplary direct liquid feed fuel cell having a fuel delivery layer.

FIG. 4A is a schematic diagram of an assembled exemplary direct liquid feed fuel cell. FIG. 4B is a cross-sectional diagram of the assembled exemplary direct liquid feed fuel cell in FIG. 4A. FIG. 4C is a detailed view of a portion of the cross-sectional diagram in FIG. 4B. FIG. 4D is a cross-sectional diagram of the assembled exemplary direct liquid feed fuel cell in FIG. 4A. FIG. 4E is a detailed view of a portion of the cross-sectional diagram in FIG. 4D.

FIG. 5 is a cross-sectional diagram of an exemplary direct liquid feed fuel cell having a fuel delivery layer with a polymer coating.

FIG. 6 is a cross-sectional diagram of an exemplary direct liquid feed fuel cell having a fuel delivery layer with a polymer coating.

FIG. 7 is a cross-sectional diagram of an exemplary direct liquid feed fuel cell having a fuel delivery layer and a fuel distribution layer.

FIG. 8 is a cross-sectional diagram of an exemplary direct liquid feed fuel cell having a fuel delivery layer and a gas diffusion layer.

FIG. 9 is a schematic diagram of an assembled exemplary liquid feed fuel cell having a fluid distribution layer.

FIG. 10 is a plot of fuel cell characteristics for an exemplary fuel cell over time. The current produced by the fuel cell over time is provided in amperes (A). The voltage produced by the fuel cell over time is provided in volts (V). The fuel cell has a fuel delivery layer impregnated with Nafion® and has tin oxide incorporated therein.

FIG. 11 is a plot of fuel cell characteristics for an exemplary fuel cell over time. The current produced by the fuel cell over time is provided in amps (A). The voltage produced by the fuel cell over time is provided in volts (V). The fuel cell has a fuel delivery layer made of porous graphite impregnated with Nafion® and a fuel distribution layer.

FIG. 12 is a plot of fuel cell characteristics for an exemplary fuel cell over time. The current produced by the fuel cell over time is provided in amps (A). The voltage produced by the fuel cell over time is provided in volts (V). The fuel cell has a fuel delivery layer made of porous graphite and has tin oxide incorporated therein.

### DETAILED DESCRIPTION OF PREFERRED EMBODIMENT(S)

A method and system are provided for delivery fuel to the anode of a liquid feed fuel cell at a concentration that is uniform independently of fuel cell spatial orientation.

Fuel cells generally have an anode and a cathode disposed on either side of an electrolyte. The anode and cathode generally comprise an electrocatalyst, such as platinum, palladium, platinum-ruthenium alloys, or other noble metals or metal alloys. The electrolyte usually comprises a proton exchange membrane (PEM), typically a perfluorosulfonic acid polymer membrane, of which Nafiong is a commercial brand. At the anode, fuel is oxidized at the electrocatalyst to produce protons and electrons. The protons migrate through the proton exchange membrane to the cathode. At the cathode, the oxidant reacts with the protons. The electrons travel from the anode to the cathode through an external circuit, producing an electrical current.

Liquid feed electrochemical fuel cells can operate using various liquid reactants. For example, the fuel stream can be methanol in a direct methanol fuel cell, or formic acid fuel in a DFAFC. The oxidant can be substantially pure oxygen or a dilute stream such as air containing oxygen.

As described above, the present technology relates to the uniform delivery of fuel to the anode of a liquid feed fuel cell independently of the orientation of the fuel cell in space. The present technology further relates to the dilution of a concentrated fuel stream and the uniform distribution of the diluted fuel to the anode of a liquid feed fuel cell independently of the spatial orientation of the fuel cell.

The embodiments will be described in detail with respect to direct formic acid fuel cells (DFAFC), with applicability to other liquid fuel cells such as methanol.

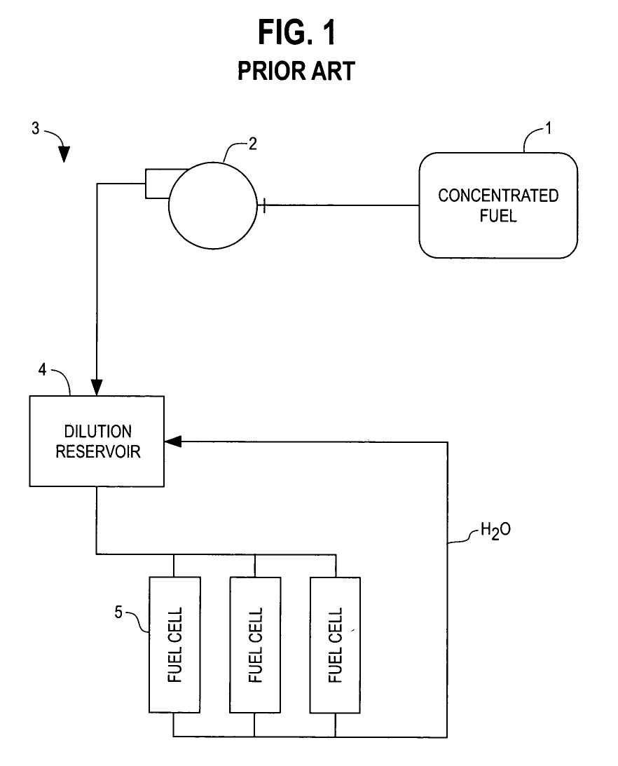

The schematic of FIG. 1 depicts a prior art fuel dilution system 3. The dilution system 3 has a concentrated fuel reservoir 1, a pump 2, a dilution reservoir 4, and one or more fuel cells 5. The concentrated fuel reservoir 1 is connected to the pump 2. The pump 2 is connected to the dilution reservoir 4. The dilution reservoir 4 is connected to the fuel cell(s) 5. The pump 2 pumps fuel from the concentrated fuel reservoir 1 to the dilution reservoir 4. The dilution reservoir contains water. The water in the dilution reservoir dilutes the fuel, which is then sent to the fuel cell(s) 5. Water from the fuel cell(s) is recycled to the dilution reservoir 4. As discussed above, this fuel dilution system adds weight, size, and mechanical complexity to the fuel cell.

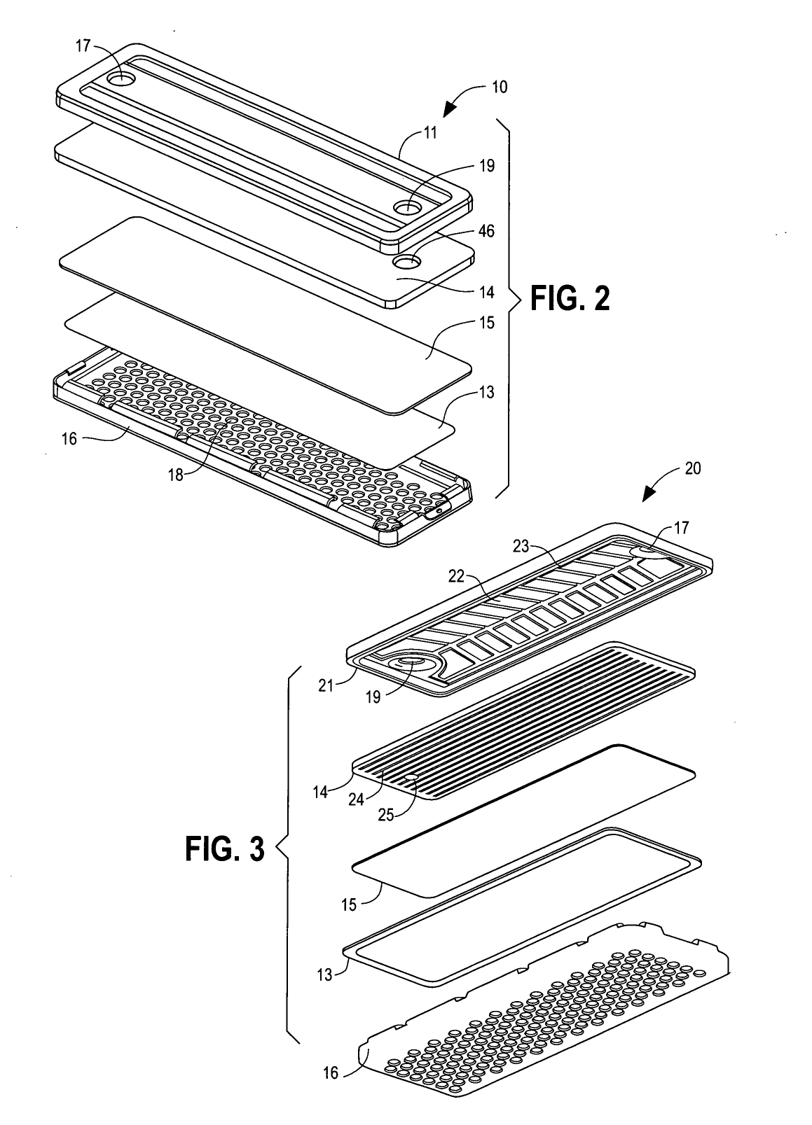

The schematic of FIG. 2 depicts an exploded view diagram of an exemplary direct liquid feed fuel cell 10 having a fuel delivery layer 14. The fuel cell 10 has an anode current collector plate 11. The anode current collector plate has a fuel inlet opening 17 and a gas outlet opening 19. The fuel cell 10 also has a fuel delivery layer 14. The fuel delivery layer 14 has a gas outlet opening 46. The fuel cell 10 also has a membrane electrode assembly (MEA) 15. The fuel cell 10 also has a gasket 13. The fuel cell 10 also has a cathode current collector 16. The cathode current collector 16 can be formed into an open box, as shown in FIG. 2. The cathode current collector 16 has a series of openings 18. The anode and cathode current collectors can be made of gold-plated stainless steel.

When the fuel cell is assembled, the layers of the fuel cell can be stacked and then compressed. The exemplary fuel cell in FIG. 2 depicts the gasket 13, the MEA 15, the fuel delivery layer 14, and the anode current collector 11 stacked inside the open box of the cathode current collector 16. This assembly is sometimes called a “unit cell.”

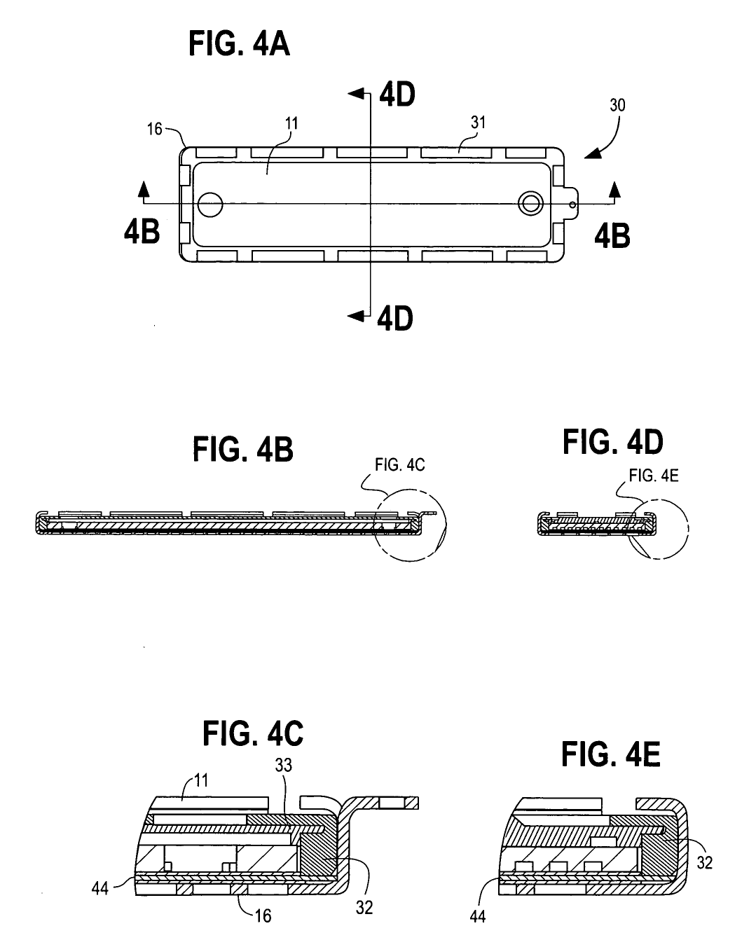

As shown in FIG. 4A, the cathode current collector 16 has tabs 31 extending from the edges of the current collector. The tabs 31 can be bent over the anode current collector 11 to enclose and compress the unit cell. The fuel delivery layer(s), gasket, and MEA are enclosed and compressed between the anode current collector 11 and the cathode current collector 16. FIGS. 4B and 4D show cross-sectional views of the assembled fuel cell. FIG. 4C shows an enlarged view of the side of an assembled and compressed unit fuel cell, including gasket 32, fuel delivery layer 33, and membrane electrode assembly 44. FIG. 4E shows an enlarged view of the end of an assembled and compressed unit fuel cell, including gasket 32 and membrane electrode assembly 44.

In a preferred embodiment, a uniform compression force is applied across the membrane so that there is suitable contact resistance across the layers, the anode and cathode current collector plates are isolated, and fuel leaks are alleviated or eliminated. FIG. 2 depicts a design where the cathode current collector 16 has crimps that retain the anode current collector plate 11 under compression. In a preferred embodiment, the anode plate 11 is preformed as a leaf spring such that when the leaf spring is flattened and the edges held, the plate applies uniform force to the fuel cell layers. When assembled, gasket 13 can be configured and folded to isolate the two electrode collector plates, or an optional rigid spacer 33 can be employed if required to withstand higher forces.

Alternatively, the mechanical crimps can be located on the anode current collector plate and the cathode collector plate 16 is pre-formed as a leaf spring. In yet another alternative embodiment, cathode and anode current collector plates are substantially planar and pre-formed as spring leafs and are retained by side clips with the gasket and rigid insulator configured to electrically isolate the plates from having a direct conduction path. In yet another embodiment of the mechanical assembly, both anode and current collector plates each have crimp features and both are L-shaped in cross-section so that the two plates interlock when crimped to provide the required or desired securing compression force. Suitable securing techniques other than crimping could also be employed.

The schematic of FIG. 3 depicts an exploded view diagram of a direct liquid feed fuel cell 20 having a fuel delivery layer 14. The cell depicted in FIG. 3 is shown from the opposite direction as the cell depicted in FIG. 2, although the cells have the same components. In FIG. 3, the anode current collector plate 21 has a fuel inlet opening 17 and a gas outlet opening 19. The anode current collector plate 21 also has a series of ridges 22 that form a series of channels 23. In FIG. 3, the fuel delivery layer 14 has a gas outlet opening 25 to allow the product gas formed at the anode of the fuel cell to escape. The fuel delivery layer 14 also has a series of channels 24. The product gas stream produced at the anode of the fuel cell travels through these channels 24 to the gas outlet opening 25. The fuel cell 20 depicted in FIG. 3 can also be assembled as described above and shown in FIGS. 4A-4E.

Concentrated fuel is fed into the fuel inlet opening 17 in the anode current collector 11, and flows through the channels 23 in the underside of the anode current collector. The channels 23 distribute the fuel relatively evenly. The channels 23 can be arranged in a fishbone pattern, as shown in FIG. 3, a serpentine pattern, or other pattern that will distribute the fuel over the entire plate.

After flowing through the fuel inlet opening 17 and across the anode current collector 11, the fuel enters the fuel delivery layer 14. The fuel delivery layer 14 retains water, and dilutes the concentrated fuel so that the fuel reaches the anode at a concentration that does not damage the membrane. The fuel reacts at the MEA to produce electricity, product gas, and water, as described above.

The product gas stream produced by the anode reaction flows through the channels 24 in the fuel delivery layer, through the gas outlet port 25 in the fuel delivery layer, and through the gas outlet port 19 in the anode current collector 11.

Some of the water formed as a product of the reaction at the cathode diffuses across the MEA and into the fuel delivery layer to dilute the concentrated fuel. The size and chemical properties of the fuel delivery layer can be selected so that the fuel delivery layer retains enough water to dilute the concentrated fuel by a predetermined dilution factor by the time the fuel reaches the anode.

Excess water and unreacted fuel flow out of the cell when the water and fuel build up such that there is an increase in pressure sufficient to push the excess fluid out of the unit fuel cell. The outflow can occur passively or active pumping from a pump can be implemented. In alternative embodiments, hydrophobic layers can be added on either or both sides of the fuel delivery layer to control the diffusion of water in the unit cell.

FIG. 9 depicts an exemplary fuel cell 80 where a fuel distribution layer distributes incoming concentrated fuel before the fuel enters the fuel delivery layer. FIG. 9 shows a fuel cell with a fuel distribution layer 80. The fuel distribution layer has a number of openings 81 formed therein. The fuel distribution layer can be made of graphite sheet material or of non-porous materials. The number, size, and distribution of the openings can be determined to achieve fuel distribution when the fuel enters the fuel delivery layer. Fuel distribution layer 80 is disposed between the anode current collector and the fuel delivery layer.

The fuel delivery layer is designed to provide a uniform fuel concentration across the planar extent of the anode, independently of the spatial orientation of the fuel cell. The fuel delivery layer can be a porous graphite plate. Suitable graphite plates are available from POCO Graphite, Inc. (Decatur, Tex., USA). Preferably, the layer has an open porosity of greater than about 25%. Open porosity is the percentage of the total volume that is open. Also, the pores are preferably from about 1 to 2 microns in diameter.

The fuel delivery layer can be impregnated with a fuel-permeable polymer. One example of a suitable fuel-permeable polymer is Nafion®, available from DuPont Chemical Co., Delaware Nafion® is a copolymer of tetrafluoroethylene and perfluorovinylether sulfonic acid. The fuel-permeable polymer can also be mixed with carbon powder. When the fuel-permeable polymer is mixed with carbon powder, the carbon powder is preferably between about 1% and about 50% by weight when considering the weight of the polymer and the carbon powder.

The fuel delivery layer can be impregnated with the fuel-permeable polymer using suitable techniques. One suitable technique is to prepare an ink solution of the fuel-permeable polymer and submerge the porous graphite plate in the ink solution for a length of time. The solution is diluted to be about 0.1% to about 20% by weight polymer. The length of time the plate is left in the ink solution will change the concentration gradient of the fuel-permeable polymer. The volume of material soaked can range from partially soaking to entirely soaking the plate. Then, the plate can be removed from the ink solution and dried.

Another suitable technique is to prepare an ink solution of the fuel-permeable polymer and partially immerse the porous graphite plate in the solution. The side of the porous graphite plate not immersed in the solution is coupled to a vacuum pump to draw the treatment solution through the plate. The ink solution is diluted to be about 0.1% to about 20% by weight polymer.

Another suitable technique is to prepare an ink solution of the fuel-permeable polymer. The solution is diluted to be about 0.1% to about 20% by weight polymer. Then the ink solution is brushed onto the top and/or bottom surface of the porous graphite plate. The solvent in the solution should be evaporated, leaving only the polymer.

The above techniques can also employ an ink solution of fuel-permeable polymer and carbon powder. Where an ink solution of fuel-permeable polymer and carbon powder is formed, the solution is diluted to be about 0.1% to about 20% by weight polymer and carbon powder.

The surface of the porous fuel delivery layer can also include a coating of a fuel-permeable polymer. The porous fuel delivery layer can be completely coated with fuel-permeable polymer, or the fuel delivery layer can be coated in a pattern. If the porous fuel delivery layer is coated in a pattern, a mask can prevent certain areas of the fuel delivery layer from being coated. The coating on the fuel delivery layer reduces the rate of diffusion of fuel and further distributes the fuel evenly across the planar extent of the anode. Where the surface of the fuel delivery layer includes a coating of a fuel-permeable polymer, some of the fuel-permeable polymer will be transferred into the interior of the fuel delivery layer because of the porosity of the fuel delivery layer.

One or more porous graphite layers in a unit fuel cell, including the fuel delivery layer, fuel distribution layer, and gas diffusion layer, can also be treated to increase the hydrophilicity of the layer(s). One suitable method is to incorporate a quantity of tin oxide in the porous graphite layer(s).

Depositing a thin layer of tin oxide on the surface or through the interior surfaces of the porous graphite layer increases the hydrophilicity of the porous graphite layer. Hydrophilic substrates can retain more water within the structure and dilute the incoming concentrated formic acid before the fuel reaches the anode catalyst layer. The hydrophilicity of a porous graphite layer is related to the amount of tin oxide deposited on the porous graphite layer, and can be controlled by varying the concentration of the tin hydroxide solution.

A preferred embodiment of the treatment process for a porous graphite layer uses tin hydroxide. The porous graphite layer is initially cleaned with 99.9+% methanol to remove organic contaminants and/or loose particles from the surface. The clean and dry porous graphite layer is then immersed in a tin hydroxide solution.

In a preferred embodiment, the tin hydroxide solution can be prepared by first preparing a 2M solution of tin chloride. Then the tin chloride solution can be mixed with 7M ammonium hydroxide. The aqueous ammonium hydroxide solution should be slowly added to the aqueous ammonium hydroxide solution. Iso-propanol can be added to the solution to promote the even distribution of the tin salt on the surface of the substrate. The pH of the final solution should be close to 1.1 and less than about 1.5.

When the substrate is immersed in the tin hydroxide solution, a vacuum can be applied over the solution during the soaking steps to help draw the solution into the pores of the porous graphite layer and wet the porous graphite layer. After soaking in the tin hydroxide solution, the porous graphite layer is heated at about 110° C. For about 30 minutes to remove solvent (water) molecules. Then the porous graphite layer is immersed in neutral buffer solution for about five minutes for conversion of the tin salt to tin hydroxide. The porous graphite layer is then heated again at about 110° C. Then the porous graphite layer is heated at a temperature greater than about 300° C. for more than 12 hours to convert the tin hydroxide to tin oxide crystals. Finally, the porous graphite layer is rinsed with distilled water and heated at about 110° C. for about 30 minutes to dry the substrate.

A measure of water retention value demonstrates the effects of the treatment and structure. The water retention value measures the retained weight of water in the fuel distribution layer. First, a porous graphite layer is dried by heating it at about 110° C. for about one hour. Then, the porous graphite layer is partially immersed in water for about ten minutes. The weight of the porous graphite layer is measured before and after immersion. The difference between the two is the water weight gain at ambient pressure.

The porous graphite layer is dried by heating it at about 110° C. for about one hour. The porous graphite layer is partially immersed in water. Then a vacuum is applied to one side of the porous graphite layer to pull additional water into the porous graphite layer. The vacuum is applied for about ten minutes. Again, the weight of the porous graphite layer is measured before and after immersion. The difference between the two is the water weight gain at vacuum.

The ratio of the water weight gain at ambient pressure to water weight gain at vacuum is then calculated to determine the wettability ratio. The higher the ratio, the better the porous graphite layer is at retaining water. For example, an untreated porous graphite plate typically has a wettability ratio of less than about 0.2. A porous graphite plate incorporating tin oxide as described herein can have a wettability ratio higher than 0.9. The wettability ratio of the fuel delivery layer can be selected to achieve a desired dilution of the concentrated fuel.

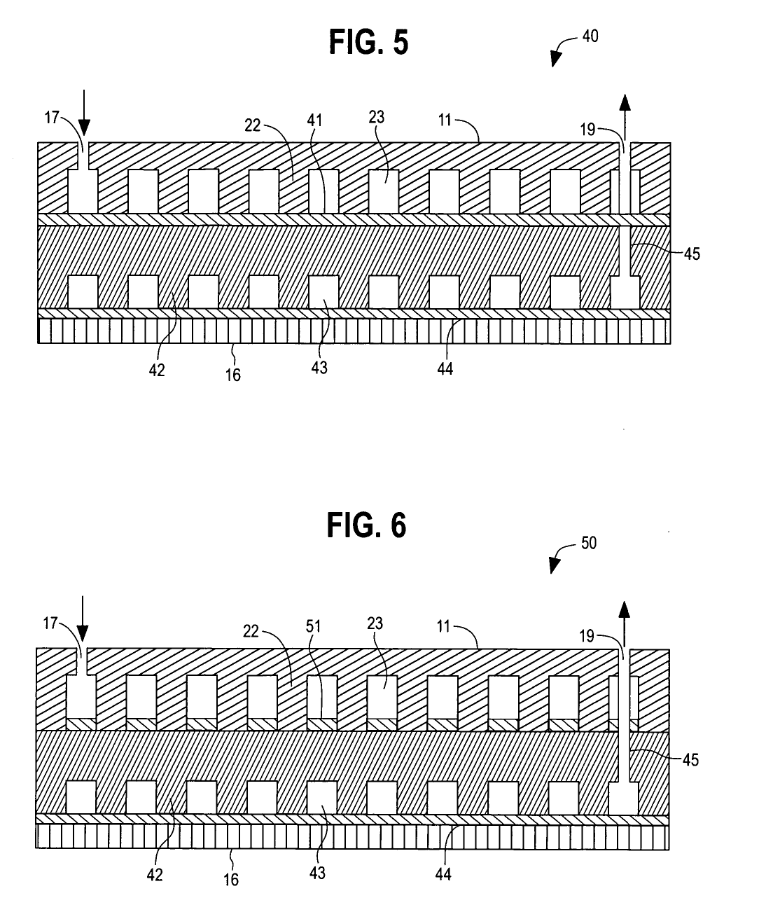

FIG. 5 shows a cross-sectional view of an exemplary fuel cell 40. In FIG. 5, the fuel delivery layer 42 has a coating 41. Fuel delivery layer 42 can be impregnated with a fuel-permeable polymer. The coating 41 comprises a fuel-permeable polymer. Concentrated fuel enters the fuel inlet opening 17 in the anode current collector 11. The fuel flows through channels 23 formed by ridges 22. The fuel then diffuses through the fuel delivery layer 42 with coating 41 to reach the membrane electrode assembly 44. The product gas stream produced during the anode reaction flows through channels 43, through gas outlet channel 45, and exits the unit cell through gas outlet port 19. FIG. 5 also shows a cathode current collector 16.

FIG. 6 shows a cross-sectional view of an exemplary fuel cell 50. In FIG. 6, the fuel delivery layer 42 is coated with a coating 51 in a pattern. Fuel delivery layer 42 can be impregnated with a fuel-permeable polymer. The coating 51 comprises a fuel-permeable polymer. The coating 51 is applied to the fuel delivery layer 42 so that the ridges 22 of the anode current collector contact the fuel delivery layer and not the coating. Applying the coating in a pattern to allow contact between the anode current collector and the fuel delivery layer improves the electrical conductivity of the cell. Concentrated fuel enters the fuel inlet opening 17 in the anode current collector 11. The fuel flows through channels 23 formed by ridges 22. The fuel then diffuses through the fuel delivery layer 42 with coating 51 to reach the membrane electrode assembly 44. The product gas stream produced during the anode reaction flows through channels 43, through a gas outlet channel, and exits the unit cell through gas outlet port 19. FIG. 6 also shows a cathode current collector 16.

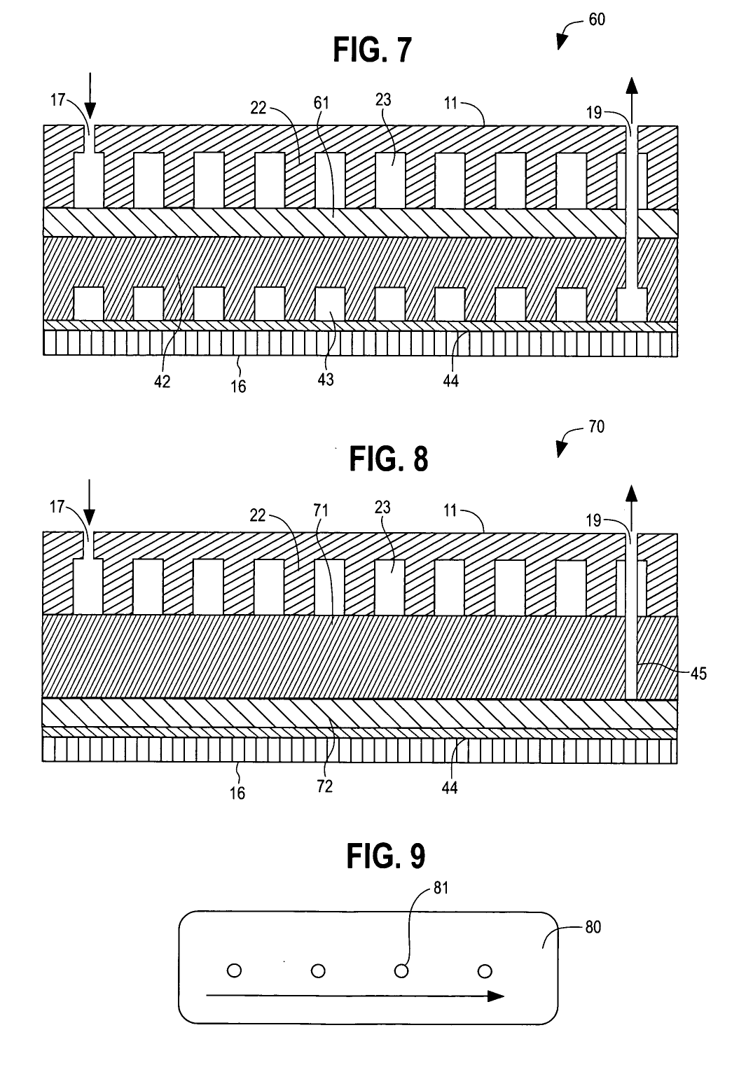

FIG. 7 shows a cross-sectional view of an exemplary fuel cell 60. Fuel cell 60 has a fuel delivery layer 42 and a fuel distribution layer 61. Preferably, the fuel distribution layer is made of fine-pore graphite with an open porosity above about 50% and pores between about 30 microns and about 100 microns in diameter, and can be either hydrophilic or hydrophobic. Suitable fuel distribution layers are available from E-Tek, Inc. (Somerset, N.J., USA). The fuel distribution layer can be treated to increase (or decrease) either its hydrophilicity or its hydrophobicity. As discussed elsewhere herein, one such treatment for increasing the hydrophilicity of a fuel distribution layer involves incorporating a quantity of tin oxide in the layer. Fuel delivery layer 42 can be hydrophilic fine-pore graphite, where the open porosity of the distribution layer is less than about 25% and the pores are less than about 1 micron in diameter. The fuel distribution layer can replace the coating of fuel-permeable polymer on the fuel delivery layer. The fuel distribution layer reduces the rate of diffusion of fuel and further distributes the fuel evenly across the planar extent of the anode. Concentrated fuel enters the fuel inlet opening 17 in the anode current collector 11. The fuel flows through channels 23 formed by ridges 22. The fuel then diffuses through the fuel distribution layer 61 and the fuel delivery layer 42 to reach the membrane electrode assembly 44. The product gas stream produced during the anode reaction flows through channels 43, through a gas outlet channel, and exits the unit cell through gas outlet port 19. FIG. 7 also shows a cathode current collector 16.

FIG. 8 shows a cross-sectional view of an exemplary fuel cell 70. Instead of channels for the product gas stream to flow through in the fuel delivery layer, exemplary fuel cell 70 has a gas diffusion layer 72. The gas diffusion layer can be made of hydrophilic fine-pore graphite. Suitable gas diffusion layers are available from E-Tek, Inc. (Somerset, N.J., USA). Preferably, the gas diffusion layer is made of hydrophilic fine-pore graphite with an open porosity above about 50% and pores between about 30 microns and about 100 microns in diameter. Concentrated fuel enters the fuel inlet opening 17 in the anode current collector 11. The fuel flows through channels 23 formed by ridges 22. The fuel then diffuses through the fuel delivery layer 71 and the gas diffusion layer 72 to reach the membrane electrode assembly 44. Fuel delivery layer 71 is preferably coated with the fuel permeable polymer. Product gas formed during the anode reaction diffuses primarily laterally through the gas diffusion layer 72, through a gas outlet channel, and exits the unit cell through gas outlet port 19. FIG. 8 also shows a cathode current collector 16.

### Exemplary Fuel Cell 1

The first exemplary fuel cell is generally consistent with the fuel cell 40 shown in FIG. 5. Element numbers from that fuel cell will be employed where appropriate for convenience. The anode current collector 11 has channels 23 distributed in a network of interlinked channels, for example the fishbone pattern shown in FIG. 3. The anode current collector 11 is made of gold-plated stainless steel. The fuel delivery layer is a porous graphite plate impregnated with NAFION® and had tin oxide incorporated therein. A porous graphite plate from POCO Graphite (Decatur, Tex., USA) was employed.

The porous graphite plate was impregnated with the NAFION® by preparing an ink solution of the fuel-permeable polymer. Then the ink solution was brushed onto the top surface of the porous graphite plate. The solvent in the solution was evaporated, leaving only the polymer.

The porous graphite plate impregnated with NAFION® had tin oxide incorporated therein. The porous graphite plate was cleaned with 99.9+% methanol to remove organic contaminants and/or loose particles from the surface.

Then the tin hydroxide solution was made by slowly adding aqueous ammonium hydroxide solution to aqueous tin chloride solution. Iso-propanol was added to the solution to promote the even distribution of the tin salt on the surface of the substrate. The pH of the tin hydroxide solution was adjusted to about 1.2.

The porous graphite plate was immersed in the tin hydroxide solution, and a vacuum was applied over the solution during the soaking steps to help draw the solution into the pores of the graphite plate and wet the porous structure. After soaking in the tin hydroxide solution for about 30 minutes, the porous graphite plate was heated at about 116° C. for about 30 minutes to remove solvent. Then the porous graphite plate was immersed in a neutral buffer solution for about five minutes for conversion of the tin salt to tin hydroxide. The porous graphite plate was then heated again at about 116° C. Then the porous graphite plate was heated at a temperature greater than about 360° C. for more than 12 hours to convert the tin hydroxide to tin oxide crystals. Finally, the porous graphite plate was rinsed with distilled water and heated at about 116° C. for about 30 minutes to dry the substrate.

A concentrated fuel solutions of 22M formic acid was employed.

The fuel cell was run at a constant current density of 100 mA/cm² (constant current of 0.71 A) for a total period of 180 hours. FIG. 8 shows data for about seventeen hours of this run. Throughout the run, the anode and the cathode were regenerated both by applying a series of positive voltage pulses to the anode without interrupting fuel flow to the anode (wet re-activation) and by applying a positive voltage pulse between the anode and the cathode while largely interrupting fuel flow to the anode (dry re-activation). Wet re-activation was performed by applying a positive voltage pulse to the anode for 1 second at intervals of about 6 minutes while the cell was running. Dry re-activation was performed by applying a positive voltage pulse to the anode at intervals of between about 45 minutes and about 2 hours. Before dry re-activation was performed, fuel flow to the anode would be interrupted and the cell current raised to 1 A to burn off remaining fuel before applying the positive pulse. Further information regarding the re-activation of the fuel cell is included in co-owned U.S. patent application Ser. No. 11/323,678, the entirety of which is hereby incorporated herein by reference.

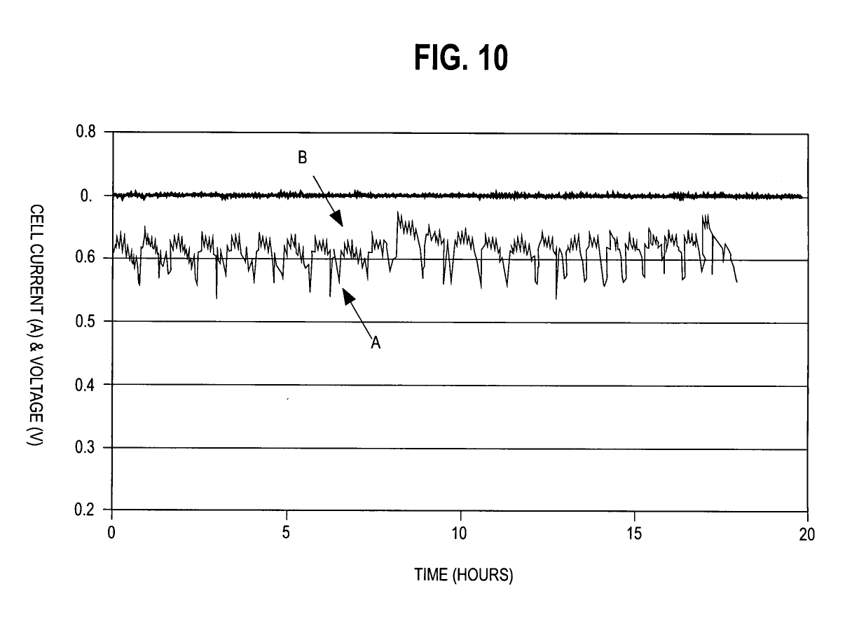

While the cell was running, the current, voltage, high frequency resistance (HFR) and temperature of the cell were recorded. FIG. 10 is a chart showing the current and voltage characteristics over time. FIG. 10 shows current in amps (A) over time. FIG. 10 also shows voltage in volts (V) over time. The onset of re-activation is shown at event A and the post re-activation voltage at event B. The temperature of the cell remained near ambient temperature over time. The high frequency resistance remained relatively constant over time. FIG. 10 demonstrates that the current and voltage, of this exemplary fuel cell are relatively constant over a period of 17 hours. The performance of this exemplary cell does not degrade substantially over time.

### Exemplary Fuel Cell 2

The second exemplary fuel cell is generally consistent with the fuel cell 60 shown in FIG. 7. Element numbers from that fuel cell will be employed where appropriate for convenience. The anode current collector 11 has channels 23 distributed in a fishbone pattern. The anode current collector 11 is made of gold-plated stainless steel. The fuel delivery layer 42 is a porous graphite plate impregnated with Nafion®, and is covered by fuel distribution layer 61. A porous graphite plate from POCO Graphite (Decatur, Tex., USA) was employed as the fuel delivery layer. A porous graphite plate from E-Tek, Inc. (Somerset, N.J., USA) was employed as the fuel distribution layer.

The fuel delivery layer was impregnated with the NAFION® by preparing an ink solution of the fuel-permeable polymer. Then the ink solution was brushed onto the top surface of the porous graphite plate. The solvent in the solution was evaporated, leaving only the polymer.

The fuel delivery layer impregnated with NAFION® also has tin oxide incorporated therein. The fuel delivery layer was cleaned with 99.9+% methanol to remove organic contaminants and/or loose particles from the surface.

The tin hydroxide solution was then made by slowly adding aqueous ammonium hydroxide solution to aqueous tin chloride solution. Iso-propanol was added to the solution to promote the even distribution of the tin salt on the surface of the substrate. The pH of the tin hydroxide solution was adjusted to about 1.2.

The fuel delivery layer was immersed in the tin hydroxide solution, and a vacuum was applied over the solution during the soaking steps to help draw the solution into the pores of the fuel delivery layer and wet the porous structure. After soaking in the tin hydroxide solution for about 30 minutes, the fuel delivery layer was heated at about 116° C. for about 30 minutes to remove solvent. Then the fuel delivery layer was immersed in a neutral buffer solution for about five minutes for conversion of the tin salt to tin hydroxide. The fuel delivery layer was then heated again at about 116° C. Then the fuel delivery layer was heated at a temperature greater than about 360° C. for more than 12 hours to convert the tin hydroxide to tin oxide crystals. Finally, the fuel delivery layer was rinsed with distilled water and heated at about 116° C. for about 30 minutes to dry the substrate.

A concentrated fuel solutions of 22M formic acid was employed.

The fuel cell was run at a constant current density of 100 mA/cm² and constant current of 0.71 A for a period of 17 hours. The same re-activation process was applied as in Exemplary Fuel Cell 1, with the exception the timing between re-activation cycles was increased to over 1 hour. The onset of re-activation is shown at event C and post re-activation at event D.

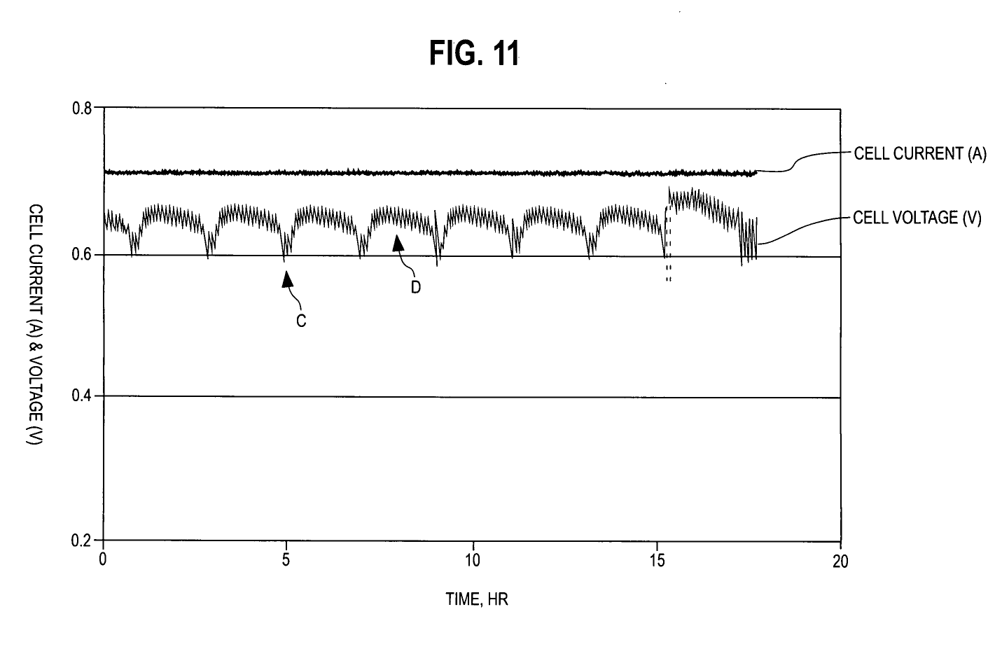

While the cell was running, the current, voltage, high frequency resistance (HFR) and temperature of the cell were recorded. FIG. 11 is a chart showing the current and voltage characteristics of the cell over time. FIG. 11 shows current in amps (A) over time. FIG. 11 also shows voltage in volts (V) over time. The cell temperature remained near ambient temperature over time. The high frequency resistance remained relatively constant over time. FIG. 11 demonstrates that the current, voltage, HFR, and temperature of this exemplary fuel cell are relatively stable over a period of 17 hours. Improved cell voltage stability results in increased time between re-activation cycles as compared with Exemplary Fuel Cell 1.

### Exemplary Fuel Cell 3

The third exemplary fuel cell is generally consistent with the fuel cell 70 shown in FIG. 8. Element numbers from that fuel cell will be employed where appropriate for convenience. The anode current collector 11 has channels 23 distributed in a fishbone pattern. The anode current collector 11 is made of gold-plated stainless steel. The fuel delivery layer 42 is a porous graphite plate. A porous graphite plate from POCO Graphite (Decatur, Tex., USA) was employed as the fuel delivery layer. A porous graphite plate from E-Tek, Inc. (Somerset, N.J., USA) was employed as the gas diffusion layer 72.

The fuel delivery layer had tin oxide incorporated therein. The fuel delivery layer was cleaned with 99.9+% methanol to remove organic contaminants and/or loose particles from the surface.

Then the tin hydroxide solution was made by slowly adding aqueous ammonium hydroxide solution to aqueous tin chloride solution. Iso-propanol was added to the solution to promote the even distribution of the tin salt on the surface of the substrate. The pH of the tin hydroxide solution was adjusted to about 1.2.

The fuel delivery layer was immersed in the tin hydroxide solution, and a vacuum was applied over the solution during the soaking steps to help draw the solution into the pores of the fuel delivery layer and wet the porous structure. After soaking in the tin hydroxide solution for about 30 minutes, the fuel delivery layer was heated at about 116° C. for about 30 minutes to remove solvent. Then the fuel delivery layer was immersed in a neutral buffer solution for about five minutes for conversion of the tin salt to tin hydroxide. The fuel delivery layer was then heated again at about 116° C. Then the fuel delivery layer was heated at a temperature greater than about 360° C. for more than 12 hours to convert the tin hydroxide to tin oxide crystals. Finally, the fuel delivery layer was rinsed with distilled water and heated at about 116° C. for about 30 minutes to dry the substrate.

A concentrated fuel solutions of 22M formic acid was employed.

The fuel cell was run at a constant current density of 100 mA/cm² and constant current of 0.71 A for a period of 17 hours. The same re-activation process was applied as for Exemplary Fuel Cell 1, with the exception that the timing between re-activation was increased to over 1 hour. The onset of re-activation is shown at event E and post re-activation at event F.

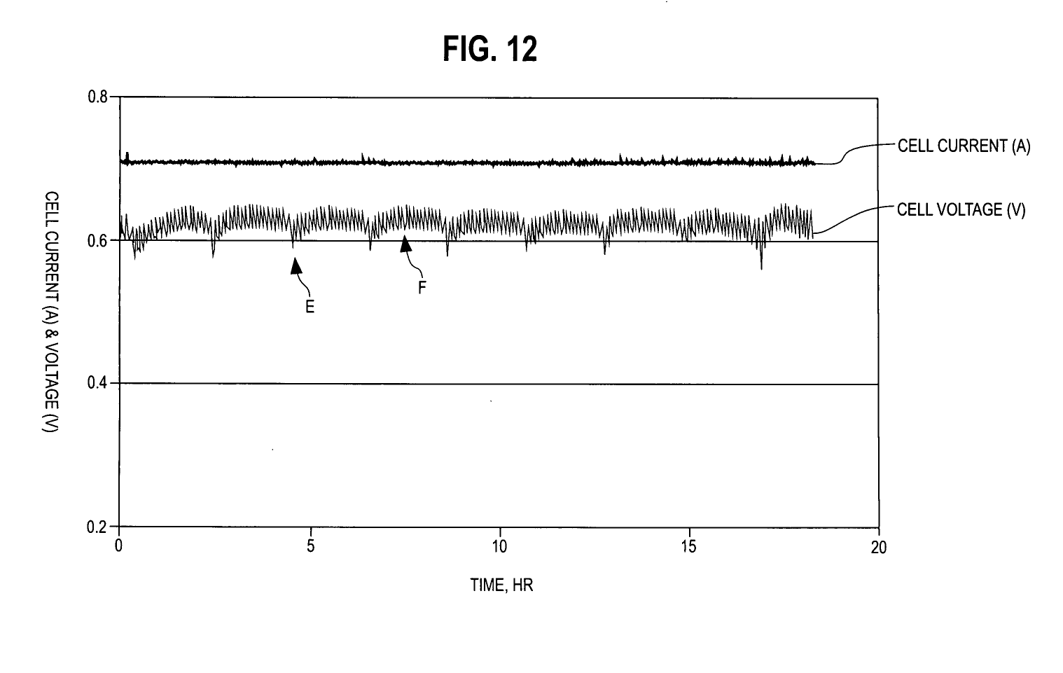

While the cell was running, the current, voltage, high frequency resistance (HFR) and temperature of the cell were recorded. FIG. 12 is a chart showing the current and voltage characteristics over time. FIG. 12 shows current in amps (A) over time. FIG. 12 also shows voltage in volts (V) over time. The cell temperature remained relatively close to the ambient temperature over time. The high frequency resistance remained relatively constant over time. FIG. 12 and the results described demonstrate that the current, voltage, HFR and temperature of this exemplary fuel cell are relatively stable over a period of 17 hours. Improved cell voltage stability results in increased time between re-activation cycles as compared with Exemplary Fuel Cells 1 and 2.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A liquid feed fuel cell comprising:
(a) an anode comprising carbon and having an anode electrocatalyst associated therewith;
(b) a cathode having a cathode electrocatalyst associated therewith;
(c) a proton exchange membrane interposed between the anode and the cathode, wherein a fluid fuel stream is directed to and oxidized at the anode; and
(d) an electrically conductive fuel delivery layer having a fuel stream side and an anode side interposed between the fluid fuel stream and the anode, said fuel delivery layer comprising hydrophilic porous graphite impregnated with a fuel-permeable polymer.

2. The liquid feed fuel cell of claim 1, wherein the fuel delivery layer has an open porosity of greater than about 25%.

3. The liquid feed fuel cell of claim 1, wherein the pores in the fuel delivery layer are between about 1 micron and about 2 microns in diameter.

4. The liquid feed fuel cell of claim 2, wherein the pores in said fuel delivery layer are between about 1 micron and about 2 microns in diameter.

5. The liquid feed fuel cell of claim 1, wherein said fuel delivery layer is rendered hydrophilic by incorporating therein a material that effects an increase in hydrophilicity of said layer.

6. The liquid feed fuel cell of claim 5 wherein said hydrophilicity-increasing material is tin oxide.

7. The liquid feed fuel cell of claim 1, wherein said fuel delivery layer has a wettability ratio of greater than about 0.2.

8. The liquid feed fuel cell of claim 1, wherein said fuel-permeable polymer is perfluorosulfonic acid polymer.

9. The liquid feed fuel cell of claim 1, wherein said fuel delivery layer further comprises a coating of fuel-permeable polymer on said fuel delivery layer surface facing said fuel stream.

10. The liquid feed fuel cell of claim 9, wherein said fuel-permeable polymer is perfluorosulfonic acid polymer.

11. The liquid feed fuel cell of claim 9, wherein said coating of fuel permeable polymer forms a pattern on said fuel delivery layer.

12. The liquid feed fuel cell of claim 1, wherein said fuel delivery layer further comprises channels to exhaust a product gas stream from said anode.

13. A liquid feed fuel cell comprising:
(a) an anode comprising carbon and having an anode electrocatalyst associated therewith;
(b) a cathode having a cathode electrocatalyst associated therewith;
(c) a proton exchange membrane interposed between said anode and said cathode, wherein a fluid fuel stream is directed to and oxidized at said anode;
(d) an electrically conductive fuel distribution layer interposed between said fluid fuel stream and said anode;
and
(e) an electrically conductive fuel delivery layer interposed between said fuel distribution layer and said anode, said fuel delivery layer comprising hydrophilic porous graphite impregnated with a fuel-permeable polymer.

14. The liquid feed fuel cell of claim 13, wherein said fuel distribution layer comprises hydrophilic porous graphite.

15. The liquid feed fuel cell of claim 14, wherein said fuel distribution layer has an open porosity of greater than about 50%.

16. The liquid feed fuel cell of claim 14, wherein said fuel distribution layer has pores that are between about 30 microns and about 100 microns in diameter.

17. The liquid feed fuel cell of claim 13, wherein said fuel distribution layer comprises graphite sheet material impregnated with polytetrafluoroethylene.

18. The liquid feed fuel cell of claim 17, wherein said fuel distribution layer has openings formed in said graphite sheet material to uniformly distribute said fuel stream across said anode planar extent.

19. The liquid feed fuel cell of claim 13, wherein said fuel delivery layer has an open porosity of greater than about 25%.

20. The liquid feed fuel cell of claim 13, wherein said pores in said fuel delivery layer are between about 1-2 microns in diameter.

21. The liquid feed fuel cell of claim 19, wherein said pores in said fuel delivery layer are between about 1-2 microns in diameter.

22. The liquid feed fuel cell of claim 13, wherein said fuel delivery layer is rendered hydrophilic by incorporating therein a material that effects an increase in hydrophilicity of said layer.

23. The liquid feed fuel cell of claim 22, wherein said hydrophilicity-increasing material is tin oxide.

24. The liquid feed fuel cell of claim 13, wherein said fuel-permeable polymer is perfluorosulfonic acid polymer.

25. The liquid feed fuel cell of claim 13, wherein said fuel delivery layer further comprises channels to exhaust a product gas stream from said anode.

26. A liquid feed fuel cell comprising:
(a) an anode comprising carbon and having an anode electrocatalyst associated therewith;
(b) a cathode having a cathode electrocatalyst associated therewith;
(c) a proton exchange membrane interposed between said anode and said cathode, wherein a fluid fuel stream is directed to and oxidized at said anode;
(d) an electrically conductive fuel delivery layer interposed between said fluid fuel stream and said anode, said fuel delivery layer comprising hydrophilic porous graphite impregnated with a fuel-permeable polymer; and
(e) a gas diffusion layer interposed between said fuel delivery layer and said anode, said gas diffusion layer comprising hydrophilic porous graphite with a porosity greater than about 50% and pores between about 30-100 microns in diameter.

27. The liquid feed fuel cell of claim 26, wherein said fuel delivery layer has an open porosity of greater than about 25%.

28. The liquid feed fuel cell of claim 26, wherein said pores of said fuel delivery layer are between about 1-2 microns in diameter.

29. The liquid feed fuel cell of claim 27, wherein said pores of said fuel delivery layer are between about 1-2 microns in diameter.

30. The liquid feed fuel cell of claim 26, wherein said fuel delivery layer is rendered hydrophilic by incorporating therein a material that effects an increase in hydrophilicity of said layer.

31. The liquid feed fuel cell of claim 30, wherein said hydrophilicity-increasing material is tin oxide.

32. The liquid feed fuel cell of claim 26, wherein said fuel-permeable polymer is perfluorosulfonic acid polymer.

33. The liquid feed fuel cell of claim 26, wherein said fuel delivery layer further comprises a coating of fuel-permeable polymer on said fuel delivery layer surface facing said fuel stream.

34. The liquid feed fuel cell of claim 33, wherein said fuel-permeable polymer is perfluorosulfonic acid polymer.

35. The liquid feed fuel cell of claim 33, wherein said coating of fuel permeable polymer forms a pattern on said fuel delivery layer.

36. A system for distributing and diluting a concentrated liquid fuel solution across an electrode having a planar conformation, the system comprising:
(a) a fuel distribution layer overlaying and fluidly connected to said electrode, said fluid distribution layer distributing said fuel solution uniformly across said fuel distribution layer planar extent; and
(b) a fuel delivery layer overlaying and fluidly connected to said electrode, said fuel delivery layer decreasing fuel concentration by a predetermined dilution factor such that diffusion of fuel toward said electrode occurs independently of system spatial orientation.

37. A method for delivering fuel to an anode of a liquid feed fuel cell at a constant concentration across said anode independently of fuel cell spatial orientation, the method comprising:
(a) delivering dosed amounts of concentrated fuel to an inlet of said fuel cell at predetermined times;
(b) distributing said fuel so that fuel concentration is constant across said anode planar extent by passing said fuel through a fuel distribution layer; and
(c) diluting said fuel by a predetermined dilution factor by passing said fuel through a fuel delivery layer that contains water and effects diffusion of said fuel independently of fuel cell spatial orientation.

38. A fuel delivery layer for a liquid feed fuel cell comprising an anode, a cathode, and a proton exchange membrane disposed between the anode and the cathode, said fuel delivery layer comprising hydrophilic porous graphite with an open porosity greater than about 25% and pore size between about 1-2 microns.

39. A liquid feed fuel cell comprising:
(a) an anode comprising carbon and having an anode electrocatalyst associated therewith;
(b) a cathode having a cathode electrocatalyst associated therewith;
(c) a proton exchange membrane interposed between said anode and said cathode, wherein a fluid fuel stream is directable to and oxidizable at said anode;
(d) an electrically conductive fuel delivery layer interposed between said fuel stream and said anode, said fuel delivery layer comprising hydrophilic fine-pore graphite impregnated with a fuel-permeable polymer;
(e) a cathode current collector plate formed of electrically conductive material, said plate electrically connected to said cathode;
(f) an anode current collector plate formed of electrically conductive material, said plate having a fuel inlet port and a waste outlet port formed therein, said anode current collector plate electrically connected to said anode;
(g) a compressible gasket; and
(h) a rigid insulating gasket;
wherein at least one of said cathode current collector plate and said anode current collector plate has securing portions extending outwardly therefrom, and said anode current collector plate, said insulating gasket, said fuel delivery layer, said anode, said proton exchange membrane, said cathode, said compressible gasket and said rigid insulating gasket are assembled in a stack with said cathode current collector plate, and wherein said fuel cell is consolidated by compressing said securing portions against said insulating gasket and the other of said at least one of said cathode current collector plate and said anode collector plate such that said fuel cell is uniformly compressed.

40. The liquid feed fuel cell of claim 39 further comprising an electrically conductive fuel distribution layer interposed between said fluid fuel stream and said fuel delivery layer, said fuel distribution layer comprising graphite sheet material impregnated with a quantity of polytetrafluoroethylene.

41. The liquid feed fuel cell of claim 39, further comprising a second insulating gasket, and wherein the other of said at least one of said cathode current collector plate and said anode current collector plate has securing portions formed therein, and said second insulating gasket is positioned adjacent the other of said at least one of said cathode current collector plate and said anode current collector plate such that said fuel cell is consolidated by compressing said securing portions against said first and second insulating gaskets and such that said fuel cell is uniformly compressed and resistance between said anode current collector plate and said cathode current collector plate is thereby reduced.
